(19) United States
(12) Patent Application Publication
(10) Pub. No.: US 2016/0169716 A1
(43) Pub. Date: Jun. 16, 2016

(54) SYSTEM AND METHOD FOR ON-SITE MEASUREMENT APPARATUS CALIBRATION

(71) Applicant: General Electric Company, Schenectady, NY (US)

(72) Inventors: John Brandon Laflen, Niskayuna, NY (US); John Anthony Vogel, Charlton, NY (US); Steven William Wik, Niskayuna, NY (US); Yakov Polishchuk, Niskayuna, NY (US); Glen William Brooksby, Glenville, NY (US)

(21) Appl. No.: 14/570,557

(22) Filed: Dec. 15, 2014

(51) Int. Cl. G01D 18/00

(52) U.S. Cl. CPC G01D 18/00

(57) ABSTRACT

A meteorological system for calibrating a field measurement apparatus includes a field measurement apparatus coupled to a field device. The measurement apparatus is configured to generate measurement signals corresponding to a physical measurement associated with the field device. The measurement signals define a raw data stream. The system also includes a mobile calibration device including a transfer function module with a resident corrective algorithm. The mobile calibration device also includes a calibration standard data module including calibration standard data associated with the measurement apparatus resident thereon. The mobile calibration device is configured to establish bi-directional communication with the measurement apparatus, facilitate shifting the measurement apparatus to a calibration mode, receive the raw data stream from the measurement apparatus, transmit the raw data stream to the transfer function module, and calibrate the field measurement apparatus. The transfer function module is configured to generate a difference data stream through the corrective algorithm.

### BACKGROUND

The field of the disclosure relates generally to measurement apparatus, and more particularly, to a system and method for calibrating field measurement apparatus on-site using a mobile calibration device.

Typically, field measurement apparatus are positioned within operational facilities close to the associated measurement points. For example, position measurement devices are located proximate the associated translatable equipment used to regulate operation of a process within an industrial facility. Such field measurement apparatus require periodic calibration checks to verify that the apparatus has stayed within calibration specifications for generating accurate and precise measurement indications. Such apparatus may require occasional calibration to restore the output indications to within the specified accuracy and precision tolerance bands.

Many known calibration services for field measurement apparatus require the associated apparatus to be removed from service and physically removed from the premises and sent to a centralized calibration facility that is typically located a significant distance from the calibration facilities. As such, the associated field measurement apparatus is considered “out-of-service” while the field measurement apparatus is in route to, and located at, and then shipped back from the calibration facility. The period during which the field measurement apparatus is out-of-service can range from a couple of days to several weeks. Operators of the process associated with the out-of-service field measurement apparatus have some options for the period while the associated apparatus is out-of service, e.g., shutdown the process, rely on an existing installed spare, replace the apparatus with a ready spare, or simply operate without the associated measurements. In addition, the operators bear the costs associated with the labor to remove, ship, and reinstall the apparatus, the shipping costs, and any loss of revenue associated with shutting the associated process down.

Other known calibration services are performed in the field with specialized calibration equipment that may be usable only with certain makes and models of field measurement apparatus. This calibration equipment needs to be checked out of the calibration facility, sent to the remote field site, and returned to the field site. Also, a number of such calibration equipment will need to be shipped to the field site. Further, a number of each make and model of calibration equipment is required to be on hand to support multiple field sites. Moreover, the calibration equipment needs to have its calibration verified on a periodic basis.

### BRIEF DESCRIPTION

In one aspect, a meteorological system for calibrating a field measurement apparatus is provided. The system includes a field measurement apparatus coupled to a field device. The field measurement apparatus is configured to generate measurement signals corresponding to a physical measurement associated with the field device within a predetermined range of measurements. The measurement signals define a raw data stream. The system also includes a mobile calibration device including a transfer function module including a corrective algorithm resident thereon, and a calibration standard data module including calibration standard data associated with the field measurement apparatus resident thereon. The mobile calibration device is configured to establish bi-directional communication with said field measurement apparatus, facilitate shifting said field measurement apparatus to a calibration mode, receive the raw data stream from said field measurement apparatus, transmit the raw data stream to said transfer function module, and calibrate the field measurement apparatus. The transfer function module is configured to generate a difference data stream through the corrective algorithm.

In another aspect, a method of determining a calibration status of a field measurement apparatus is provided. The method includes establishing bi-directional communication with the field measurement apparatus through a mobile calibration device and exercising the field measurement apparatus through a predetermined range of physical translation. The method also includes generating measurement signals corresponding to the physical translation, where the measurement signals define a raw data stream. The method further includes transmitting the raw data stream from the field measurement apparatus to a transfer function module within the mobile calibration device. The method also includes determining a difference signal from a first corrective algorithm resident within the transfer function module and calibrating the field measurement apparatus.

### DRAWINGS

These and other features, aspects, and advantages of the present disclosure will become better understood when the following detailed description is read with reference to the accompanying drawings in which like characters represent like parts throughout the drawings, wherein:

FIG. 1 is a block diagram of an exemplary computing device;

FIG. 2 is a block diagram of an exemplary system for calibrating a field measurement apparatus that may include the computing device shown in FIG. 1;

FIG. 3 is a block diagram of the system shown in FIG. 2 for calibrating a field measurement apparatus;

FIG. 4 is a block diagram of an exemplary measurement apparatus that may be calibrated with the system shown in FIGS. 2 and 3;

FIG. 5 is a flow chart for an exemplary method of initial calibration data collection for the measurement apparatus shown in FIGS. 2, 3, and 4 using the system shown in FIGS. 2 and 3; and

FIG. 6 is a flow chart for an exemplary method of calibrating the measurement apparatus shown in FIG. 4 using the system shown in FIGS. 2 and 3.

Unless otherwise indicated, the drawings provided herein are meant to illustrate features of embodiments of this disclosure. These features are believed to be applicable in a wide variety of systems comprising one or more embodiments of this disclosure. As such, the drawings are not meant to include all conventional features known by those of ordinary skill in the art to be required for the practice of the embodiments disclosed herein.

### DETAILED DESCRIPTION

In the following specification and the claims, reference will be made to a number of terms, which shall be defined to have the following meanings.

The singular forms of “a,” “an,” and “the,” include plural references unless the context clearly indicated otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

As used herein, the terms “processor” and “computer,” and related terms, e.g., “processing device,” “computing device,” and “controller” are not limited to just those integrated circuits referred to in the art as a computer, but broadly refers to a microcontroller, a microcomputer, a programmable logic controller (PLC), and application specific integrated circuit, and other programmable circuits, and these terms are used interchangeably herein. In the embodiments described herein, memory may include, but it not limited to, a computer-readable medium, such as a random access memory (RAM), a computer-readable non-volatile medium, such as a flash memory. Alternatively, a floppy disk, a compact disc-read only memory (CD-ROM), a magneto-optical disk (MOD), and/or a digital versatile disc (DVD) may also be used. Also, in the embodiments described herein, additional input channels may be, but are not limited to, computer peripherals associated with an operator interface such as a mouse and a keyboard. Alternatively, other computer peripherals may also be used that may include, for example, but not be limited to, a scanner. Furthermore, in the exemplary embodiment, additional output channels may include, but not be limited to, an operator interface monitor.

Further, as used herein, the terms “software” and “firmware” are interchangeable, and include any computer program storage in memory for execution by personal computers, workstations, clients, and servers.

As used herein, the term “non-transitory computer-readable media” is intended to be representative of any tangible computer-based device implemented in any method of technology for short-term and long-term storage of information, such as, computer-readable instructions, data structures, program modules and sub-modules, or other data in any device. Therefore, the methods described herein may be encoded as executable instructions embodied in a tangible, non-transitory, computer-readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including without limitation, volatile and non-volatile media, and removable and non-removable media such as firmware, physical and virtual storage, CD-ROMS, DVDs, and any other digital source such as a network or the Internet, as well as yet to be developed digital means, with the sole exception being transitory, propagating signal.

Furthermore, as used herein, the term “real-time” refers to at least one of the time of occurrence of the associated events, the time of measurement and collection of predetermined data, the time to process the data, and the time of a system response to the events and the environment. In the embodiments described herein, these activities and events occur substantially instantaneously.

As used herein, the phrase “measurement apparatus calibration facility” refers to a facility that calibrates measurement apparatus of substantially all makes and models. Such “measurement apparatus calibration facility” is typically located remotely and separate from areas where field measurement apparatus is typically used.

As used herein, the terms “field” and “on-site”, and related terms, e.g., “field site” refer to any area outside of the measurement apparatus calibration facility. Particularly, such terms refer to an area proximate a location where a field measurement apparatus is used that is located a predetermined distance from a measurement apparatus calibration facility. Such predetermined distance ranges from tens to hundreds of miles. Moreover, as used herein, the term “off-site”, and related terms, refer to the measurement apparatus calibration facility.

The meteorological systems and methods described below provide cost-effective methods for calibrating field measurement apparatus. Specifically, utilizing the embodiments described herein, a field measurement apparatus is calibrated on-site using a mobile calibration device. Calibrating field measurement apparatus on-site reduces the potential for the field measurement apparatus being taken out of service, physically removed from the premises, and sent to a centralized calibration facility that is typically located a significant distance from the calibration facilities. Therefore, a time period for which the associated field measurement apparatus is considered “out-of-service” is significantly reduced. In addition, the he costs associated with the labor to remove, ship, and reinstall the apparatus, the shipping costs, and any loss of revenue associated with shutting the associated process down is significantly reduced. Furthermore, reliance on specialized calibration equipment that may be usable only with certain makes and models of field measurement apparatus, and also needs to be calibrated, is significantly reduced. Moreover, the meteorological systems and methods described below facilitate data preservation through network-based, including cloud-mediated, storage and data transfer such that each measurement apparatus has its own history.

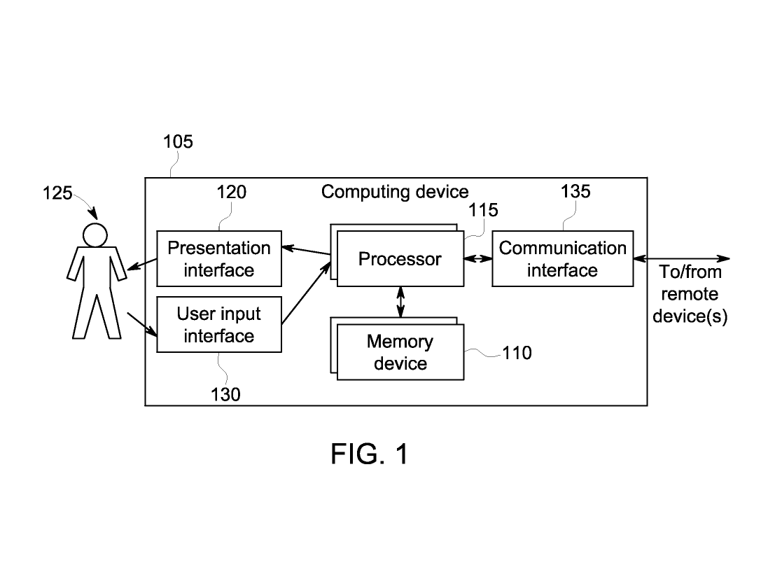

FIG. 1 is a block diagram of an exemplary computing device 105 that may be used in embodiments disclosed herein. More specifically, computing device 105 facilitates, without limitation, calibrating field measurement apparatus (not shown in FIG. 1) on-site. Computing device 105 includes a memory device 110 and a processor 115 operatively coupled to memory device 110 for executing instructions. In some embodiments, executable instructions are stored in memory device 110. Computing device 105 is configurable to perform one or more operations described herein by programming processor 115. For example, processor 115 may be programmed by encoding an operation as one or more executable instructions and providing the executable instructions in memory device 110. In the exemplary embodiment, memory device 110 is one or more devices that enable storage and retrieval of information such as executable instructions and/or other data. Memory device 110 may include one or more computer readable media.

Memory device 110 may be configured to store operational measurements including one or more of, without limitation, measurement information, measured data, established calibration data, position data, time data, accuracy data, corrective algorithms, locations for calibration, instructions on how to collect measurement information, and any other type of data. Also, memory device 110 includes, without limitation, sufficient data, algorithms, and commands to facilitate calibrating field measurement apparatus on-site and determining a location for a particular field measurement apparatus to be calibrated.

In some embodiments, computing device 105 also includes a presentation interface 120 coupled to processor 115. Presentation interface 120 presents information, such as a user interface, to an operator or user 125. In some embodiments, presentation interface 120 includes one or more display devices. In some embodiments, presentation interface 120 presents calibration details for a field measurement apparatus. Also, in some embodiments, computing device 105 includes a user interface 130. In the exemplary embodiment, user input interface 130 is coupled to processor 115 and received input from user 125.

A communication interface 135 is coupled to processor 115 and is configured to be coupled in communication with one or more other devices, such as another computing device 105, and to perform input and output operations with respect to such devices while performing as an input channel. Communication interface 135 may receive data from and/or transmit data to one or more remote devices. For example, a communication interface 135 of one computing device 105 may transmit a corrective algorithm to the communication interface 135 of another computing device 105. In some embodiments, communication interface 135 is a wireless interface. In some embodiments, communication interface 135 is configured to enable communication through a short range wireless communication protocol such as Bluetooth™ or Z-Wave™, through a wireless local area network (WLAN) implemented pursuant to an IEEE (Institute of Electrical and Electronics Engineers) 802.11 standard (i.e., WiFi), and/or through a mobile phone (i.e., cellular) network (e.g., Global System for Mobile communications (GSM), 3G, 4G) or other mobile data network (e.g., Worldwide Interoperability for Microwave Access (WIMAX)), or a wired connection (i.e., one or more conductors for transmitting electrical signals). In embodiments that communication interface 135 couples computing device 105 to one or more field measurement apparatus, communication interface 135 may include, for example, one or more conductors for transmitting electrical signals and/or power to and/or from the field measurement apparatus.

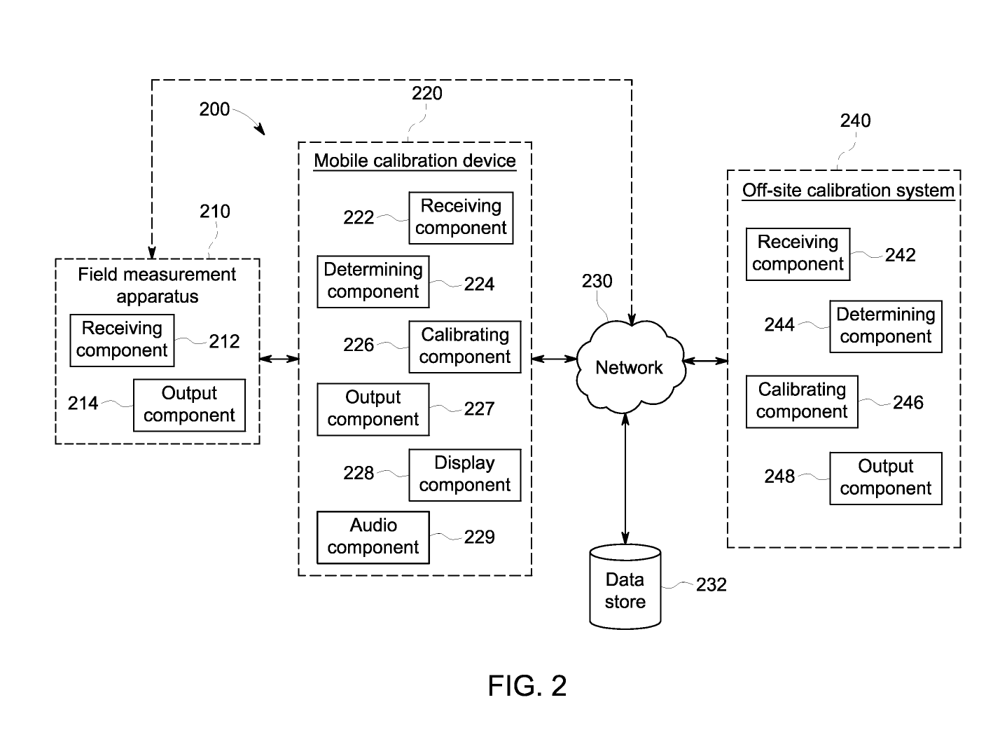

FIG. 2 is a block diagram of an exemplary meteorological system 200 for measurement apparatus calibration that may include the computing device (shown in FIG. 1). Meteorological system 200 includes a field measurement apparatus 210, a mobile calibration device 220, a data storage device 232, a remote calibration system, i.e., an off-site calibration system 240, all in communication with one another through a network 230. Network 230 includes one or more of, without limitation, one or more local area networks (LANs), wide area networks (WANs), the Internet, servers located in a cloud environment, and a commercial or private mobile phone network. Network 230 is cloud enabled. Any number of field measurement apparatus 210, mobile calibration devices 220, data storage devices 232, and off-site calibration systems 240 that enable operation of meteorological system 200 as described herein are employed in meteorological system 200.

Data storage device 232 stores data associated with field measurement apparatus 210, mobile calibration device 220, and off-site calibration system 240. Such data includes one or more of, without limitation, makes, model numbers, and serial numbers of field measurement apparatus 210, measurement information, measured data, standard calibration data, position data, time data, location data, accuracy data, locations for calibration, corrective algorithms, instructions on how to collect measurement information, and any other type of data that enables operation of meteorological system 200 as described herein. Data storage device 232 is searchable for one or more of the items stored in association therewith. Additionally, though illustrated as a single independent component, data storage device 232, in some embodiments, is a plurality of storage devices, for instance a database cluster, portions of which may reside in association with mobile calibration device 220, off-site calibration system 240, another external computing device 105 (as shown in FIG. 1), and any combination thereof.

Measurement information includes measured data and established calibration data. Measured data is any measurement taken by field measurement apparatus 210 and mobile calibration device 220, such as, without limitation, physical position, apparatus location, measurement output, e.g., milliamperes (ma), and time, i.e., real-time data and historical data. Established calibration data is any measurement already defined as a correct measurement, for example, and without limitation, original equipment manufacturers' (OEMs') calibration standards, actual measurement data recorded using standard measurement devices, e.g., and without limitation, calibration blocks and visual/physical verification, and historical data.

Field measurement apparatus 210 is any measurement apparatus that can be calibrated, such as, without limitation, micrometers, torque wrenches, dial indicators, taper gauges, digital calipers, and radial and linear encoders that are based on at least one of optical, inductive, capacitive, magnetic, and resistive technologies. Field measurement apparatus 210 includes various modes, such as, without limitation, a calibration mode that facilitates calibration of field measurement apparatus 210 and a measurement mode that is the typical mode of operation for field measurement apparatus 210 when placed into service. Field measurement apparatus 210 includes a receiving component 212 and an output component 214. Receiving component 212 receives information from mobile calibration device 220 and from data storage device 232 and off-site calibration system 240 through mobile calibration device 220. Information receiving component 222 receives, for example, and without limitation, updated calibration standard data and calibration measurement correction data associated with calibrating field measurement apparatus 210. Output component 214 sends information to mobile calibration device 220 and to data storage device 232, and off-site calibration system 240 through mobile calibration device 220. Information output component 214 sends, one or more of, without limitation, makes, model numbers, and serial numbers of field measurement apparatus 210, measurement information, measured data, standard calibration data, position data, time data, location data, accuracy data, and any other type of data associated with calibrating field measurement apparatus 210.

In some embodiments, the full range of bi-directional communications between field measurement apparatus 210 and data store 232 and off-site calibration system 240 is enabled through direct communication links of field measurement apparatus 210 to network 230. Also, in some embodiments, field measurement apparatus 210 communicates with resources through network 230 to enable remote correction of real-time raw data such that more precise and accurate real-time measurements are transmitted from apparatus 210. Moreover, in some embodiments, field measurement apparatus 210 includes sufficient hardware and software resources to enable real-time self-correction of raw data such that more precise and accurate real-time measurements are transmitted therefrom.

In the exemplary embodiment, mobile calibration device 220 calibrates field measurement apparatus 210 on-site. Also, mobile calibration device 220 facilitates determining if field measurement apparatus 210 can be calibrated on-site or requires off-site calibration. Furthermore, mobile calibration device 220 facilitates determining a specific off-site location for field measurement apparatus 210 to be calibrated.

In some embodiments, mobile calibration device 220 is physically connected to field measurement apparatus 210 through an umbilical device, e.g., and without limitation, a universal serial bus (USB) cable. In other embodiments, mobile calibration device 220 is wirelessly in communication with field measurement apparatus 210. Mobile calibration device 220 is any type of mobile device including, but not limited to, a hand-held device including one of a laptop computer, a smart phone, a tablet computer, and a personal digital assistant (PDA). Also, in some embodiments, mobile calibration device 220 is maintained proximate field measurement apparatus 210 as a semi-permanent resource to facilitate local correction of real-time raw data such that more precise and accurate real-time measurements are transmitted from apparatus 210, where the term “semi-permanent” refers the relatively easy replacement of one device 220 with another.

Mobile calibration device 220 is a computing device, such as computing device 105 (shown in FIG. 1). Generally, mobile calibration device 220 includes a receiving component 222, a determining component 224, a calibrating component 226, an output component 227, a display component 228, and an audio component 229. In the exemplary embodiment, mobile calibration device 220 is a single device that includes receiving component 222, determining component 224, calibrator component 226, output component 227, display component 228, and audio component 229 at one physical location. In other embodiments, mobile calibration device 220 is a virtual assembly of a combination of receiving component 222, determining component 224, calibrator component 226, output component 227, display component 228, and audio component 229 such that the components are spread across two or more separate devices at two or more separate locations. Each component is described further below.

Receiving component 222 of mobile calibration device 220 receives information from, without limitation, field measurement apparatus 210, data storage device 232, and off-site calibration system 240. Information receiving component 222 receives data including one or more of, without limitation, makes, model numbers, and serial numbers of field measurement apparatus 210, measurement information, measured data, standard calibration data, position data, time data, location data, accuracy data, and any other type of data associated with calibrating field measurement apparatus 210.

Determining component 224 analyzes information received by receiving component 222 and determines one or more of, without limitation, a specific location and a type of location at which field measurement apparatus 210 can be calibrated based on comparing the measured data to the established calibration data. Based on the comparison between measured data and established calibration data, determining component 224 determines that calibration is necessary if the measured data deviates from the established calibration data by a predetermined margin. If calibration is necessary, then determining component 224 communicates with calibrating component 226 to calibrate field measurement apparatus 210, as discussed further below. Determining component 224 determines that calibration of field measurement apparatus 210 can take place on-site. Alternatively, determining component 224 determines that calibration of field measurement apparatus 210 cannot take place on-site. If calibration of field measurement apparatus 210 cannot take place on-site, determining component 224 determines what information should be sent to off-site calibration system 240 for assistance and analysis.

Calibrating component 226 analyzes the information received by receiving component 222 and uses one or more appropriate corrective algorithms (discussed further below) to apply to calibrate field measurement apparatus 210. Alternatively, raw measurement data from field measurement apparatus 210 is transmitted to calibrating component 226 such that the data is corrected and transmitted to either field measurement apparatus 210 or any other indicator directly from mobile calibration device 220.

Output component 227 sends information to off-site calibration system 240. For example, output component 227 sends measured data and updated calibration standard data to off-site calibration system 240 so that off-site calibration system 240 facilitates calibration of field measurement apparatus 210. Further, output component 227 also sends information to display component 228 and to audio component 229 to be presented to the user. Information that output component 227 sends to display component 228 and audio component 229 includes one or more of, without limitation, an indication field measurement apparatus 210 can be calibrated on-site, an indication that field measurement apparatus 210 cannot be calibrated on-site, a type of location at which field measurement apparatus 210 can be calibrated, a specific measurement apparatus calibration facility at which field measurement apparatus 210 can be calibrated, and an indication that field measurement apparatus 210 has been successfully calibrated. The display component 228 provides a visual display of information such as a text message, email, or any other visual alerts. Audio component 229 provides audio information, such as a voice message, or any other audio alerts.

Additionally, output component 227 provides a user the necessary instructions for obtaining measurement information from field measurement apparatus 210. For example, in some embodiments, output component 227 provides instructions for a user to use field measurement apparatus 210 against a calibrated component such that measurements taken by field measurement apparatus 210 are associated with the measured data and the measurements of the calibrated component are associated with the established calibration data.

Off-site calibration system 240 assists mobile calibration device 220 with one or more of, without limitation, calibrating field measurement apparatus 210 on-site, determining a type of location at which field measurement apparatus 210 can be calibrated, and determining a specific location, such as a measurement apparatus calibration facility, for field measurement apparatus 210 to be calibrated. Off-site calibration system 240 includes a computing device, such as computing device 105 described with reference to FIG. 1. Generally, off-site calibration system 240 includes a receiving component 242, a determining component 244, a calibrating component 246, and an output component 248. In some embodiments, off-site calibration system 240 is located at a measurement apparatus calibration facility. In other embodiments, off-site calibration system 240 is separate from a measurement apparatus calibration facility. Additionally, in some embodiments, off-site calibration system 240 is a virtual assembly of a combination of receiving component 242, determining component 244, calibrator component 246, and output component 248 such that the components are spread across two or more locations on two or more separate devices.

In some embodiments, off-site calibration system 240 assists mobile calibration device 220 when mobile calibration device 220 does not have a necessary corrective algorithm to apply to field measurement apparatus 210 for calibration. For example, in some embodiments, off-site calibration system 240 has access to one or more corrective algorithms that are not available to mobile calibration device 220. In other embodiments, off-site calibration system 240 assists mobile calibration device 220 when mobile calibration device 220 is unable to determine if field measurement apparatus 210 requires calibration.

In some embodiments, the full range of bi-directional communications between field measurement apparatus 210 and off-site calibration system 240 is enabled through direct communication links of field measurement apparatus 210 to network 230. Also, in some embodiments, field measurement apparatus 210 communicates with resources within off-site calibration system 240 through network 230 to enable real-time remote correction of real-time raw data such that more precise and accurate real-time measurements are transmitted from apparatus 210.

Receiving component 242 of the off-site calibration system 240 receives information from, for example and without limitation, mobile calibration device 220 and data storage device 232. The information receiving component 242 receives data, including one or more of, without limitation, makes, model numbers, and serial numbers of field measurement apparatus 210, measurement information, measured data, standard calibration data, position data, time data, location data, accuracy data, and any other type of data associated with calibrating field measurement apparatus 210.

Determining component 244 analyzes information received by receiving component 242 and determines one or more of, without limitation, a specific location, such as a measurement apparatus calibration facility, and type of location at which field measurement apparatus 210 can be calibrated based on, without limitation, comparing measured data to the established calibration data. Based on the comparison between the measured data and the established calibration data, determining component 244 determines that calibration is necessary if the measured data deviates from the established calibration data by a predetermined margin. If calibration is necessary, then determining component 244 communicates with the calibrating component 246 to calibrate field measurement apparatus 210, as discussed further below. Determining component 244 determines that calibration of field measurement apparatus 210 can take place on-site. Alternatively, determining component 244 determines that calibration of field measurement apparatus 210 cannot take place on-site. If calibration of field measurement apparatus 210 cannot take place on-site, determining component 244 determines what information should be sent to any other portion of off-site calibration system 240 for assistance and analysis.

Calibrating component 246 analyzes the information received by receiving component 242 and uses one or more appropriate corrective algorithms (discussed further below) to apply to calibrate field measurement apparatus 210. Alternatively, raw measurement data from field measurement apparatus 210 is transmitted to calibrating component 246 such that the data is corrected and transmitted to either field measurement apparatus 210 or any other indicator directly from off-site calibration system 240.

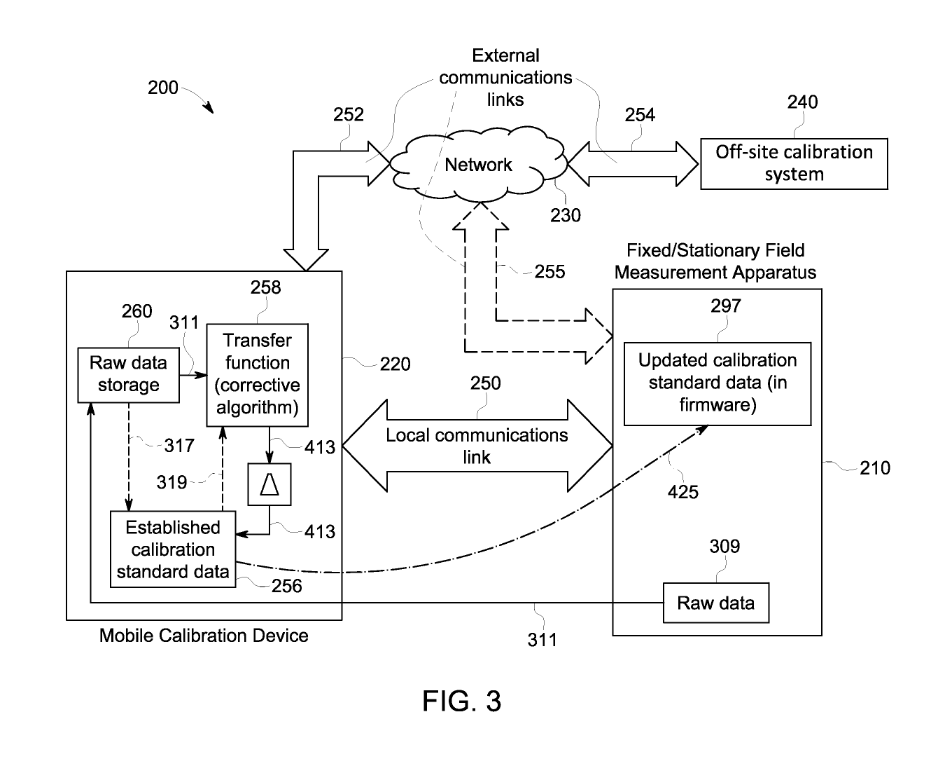

FIG. 3 is a block diagram of meteorological system 200 for calibrating field measurement apparatus 210. In the exemplary embodiment, mobile calibration device 220 is a hand-held portable device that includes receiving component 222 and output component 227 (both shown in FIG. 2), facilitating establishment of a local bi-directional communications link 250 and external bi-directional communications links 252 and 254 between mobile calibration device 220 and network 230 and between network 230 and off-site calibration system 240, respectively. In some embodiments, field measurement apparatus 210 is configured to establish an external bi-directional communications link 255 between field measurement apparatus 210 and network 230.

Also, in the exemplary embodiment, mobile calibration device 220 includes a plurality of software and hardware modules that enable operation of determining component 224 and calibrating component 226 (both shown in FIG. 2). Mobile calibration device 220 includes a calibration standard data module 256 that is configured to store data associated each field measurement apparatus 210. Such data stored within calibration standard data module 256 includes measurement information as described above including measured data and established calibration data. Measured data is any measurement taken by field measurement apparatus 210 and mobile calibration device 220, such as, without limitation, physical position, apparatus location, measurement output, e.g., milliamperes (ma), and time. Established calibration data is any measurement already defined as a correct measurement, for example, and without limitation, original equipment manufacturers' (OEMs′) calibration standards, actual measurement data recorded using standard measurement devices, e.g., and without limitation, calibration blocks and visual/physical verification, and historical data. In addition, such data includes one or more of, without limitation, makes, model numbers, and serial numbers of field measurement apparatus 210, and any other type of data associated with calibrating field measurement apparatus 210.

Further, in the exemplary embodiment, mobile calibration device 220 includes a transfer function module 258 that includes at least one corrective algorithm (discussed further below) resident thereon. Transfer function module 258 is configured to compare determine a difference between calibration data collected from field measurement apparatus 210 in real-time against a corrective algorithm at least partially derived from the data resident on calibration standard data module 256, and in some embodiments, data received through network 230.

Moreover, in some embodiments of mobile calibration device 220, device 220 includes an optional raw data storage module 260 that receives and stores raw measurement data collected from field measurement apparatus 210.

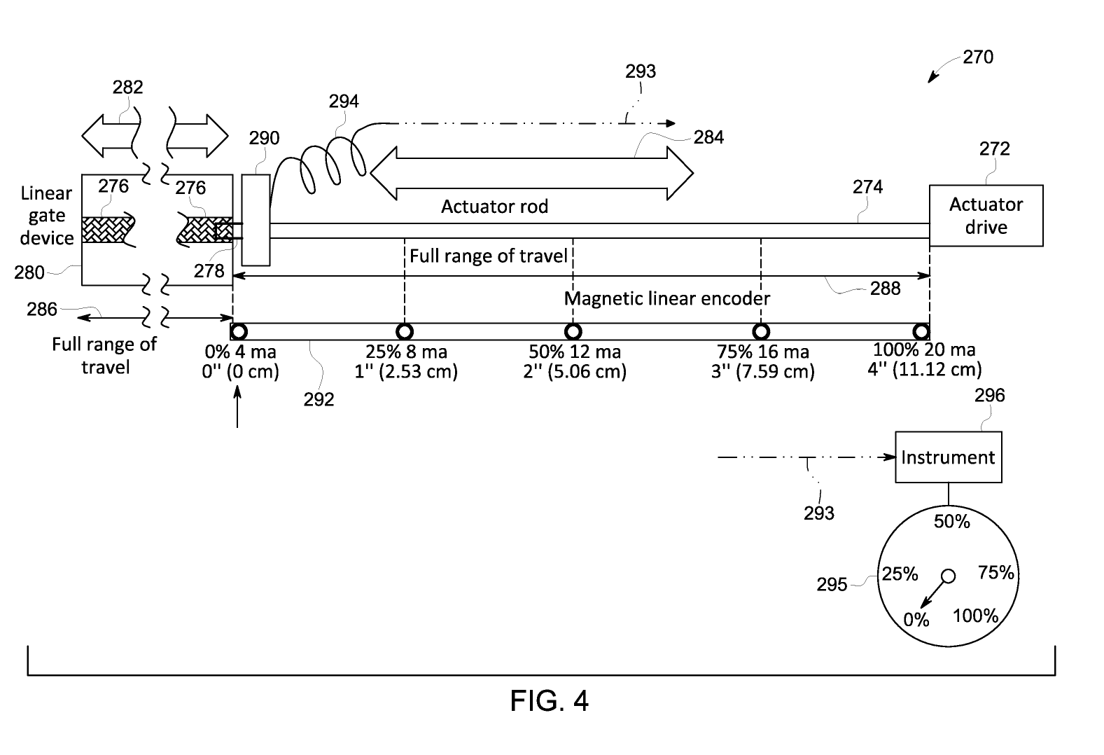

FIG. 4 is a block diagram of field measurement apparatus 210 that may be calibrated with mobile calibration device 220 (shown in FIGS. 2 and 3). In the exemplary embodiment, field measurement apparatus 210 is a magnetic linear encoder coupled to a field control device 270 that is configured to operate in a substantially linear manner. Alternatively, field measurement apparatus 210 and field control device 270 are any apparatus and devices that enable operation of meteorological system 200 as described herein, including, without limitation, rotary magnetic encoders and rotary control devices, e.g., and without limitation, geared drive units.

In the exemplary embodiment, field control device 270 includes an actuator drive 272 that is any type of actuator that enables operation of field control device 270 as described herein, including, without limitation, a geared carriage drive, a constant speed motor, and a variable speed drive (VSD). Field control device 270 also includes an actuator rod 274 coupled to actuator drive 272. Control device 274 further includes a linear gate device 276 coupled to actuator rod 274 through a mechanical coupler 278. Linear gate device 276 is positioned within a fluid conduit 280 and is configured to regulate fluid flow through conduit 280 as a function of a linear position of linear gate device 276. In operation, actuator drive 272 receives operating commands from a control system (not shown) that cause actuator drive 272 to regulate the position of linear gate device 276 through movement of actuator rod 274, as indicated by bi-directional arrows 282 and 284, respectively. A full range of travel of linear gate device 276 and actuator rod 274 are shown with bi-directional arrows 286 and 288, respectively. The full ranges of travel for device 276 and rod 274 are substantially similar, i.e., in the exemplary embodiment, approximately 4 inches (in) (11.12 centimeters (cm)). As shown in FIG. 4, linear gate device 276 is fully closed.

Also, in the exemplary embodiment, field measurement apparatus 210 is a magnetic linear encoder that includes a magnetic sensor 290 fixedly coupled to actuator rod 274 such that magnetic sensor moves with rod 274. Field measurement apparatus 210 also includes a stationary magnetic band 292 that includes a plurality of permanent magnets (not shown) positioned thereon with a predetermined spacing. Magnetic band 292 is positioned proximate the travel path of magnetic sensor 290. In operation, as actuator rod 274 travels to the right and linear gate device 276 opens, magnetic sensor 290 travels to the right and detects the permanent magnets of magnetic band 292. Magnetic sensor 290 generates analog position signals 293 that are transmitted from magnetic sensor 290 through an output signal cable 294. Alternatively, analog position signals 293 are transmitted through any wireless technology that enables operation of field measurement apparatus 210 as described herein. Analog position signals 293 are received through the associated control system and are transmitted to an analog gauge 295 through an instrument 296. Alternatively, rather than an analog gauge 295, a digital readout is used.

In the exemplary embodiment, magnetic band 292 is shown with actual position values of 0% at 0 in. (0 cm), 25% at 1 in. (2.54 cm), 50% at 2 in. (5.06 cm), 75% at 3 in. (7.59 cm), and 100% at 4 in. (11.12 cm). Electric current outputs corresponding to 0%, 25%, 50%, 75%, and 100% are 4 ma, 8 ma, 12 ma, 16 ma, and 20 ma, respectively. Gauge 295 has markings equivalent to 0%, 25%, 50%, 75%, and 100%.

Referring again to FIG. 3, in the exemplary embodiment, field measurement apparatus 210 is a device substantially fixed to a system being controlled. Receiving component 212 and output component 214 (both shown in FIG. 2) facilitate establishment of local bi-directional communications link 250 between mobile calibration device 220 and field measurement apparatus 210. In the exemplary embodiment, field measurement apparatus 210 also includes sufficient read only memory (ROM) resources, i.e., firmware 297, such that the most recently updated calibration standard data associated with field measurement apparatus 210 is residing thereon. This calibration standard data may be updated through mobile calibration device 220. Alternatively, field measurement apparatus 210 only includes sufficient ROM resources to maintain apparatus information, such as, and without limitation, model and serial number data.

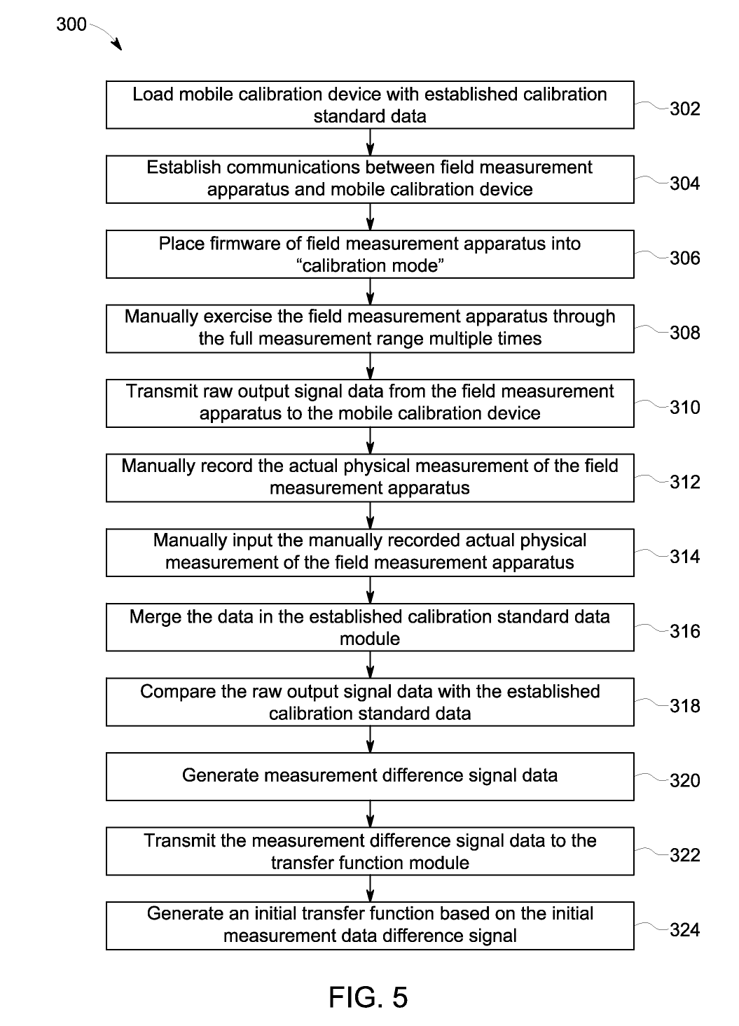

FIG. 5 is a flow chart for an exemplary method 300 of initial calibration data collection for field measurement apparatus 210 (shown in FIGS. 2, 3, and 4) using meteorological system 200 (shown in FIGS. 2 and 3). The purpose of method 300 is to generate an initial, i.e., baseline iteration of established calibration standard data, where such established calibration standard data is used as the standard for calibration of field measurement apparatus 210. Also, such established calibration standard data is used to generate an initial transfer function, i.e., corrective algorithm. Furthermore, the established calibration standard data and the corrective algorithm are stored within mobile calibration device 220 and off-site calibration system 240 (both shown in FIGS. 2 and 3). Method 300 is performed in the field with mobile calibration device 220 proximate field measurement apparatus 210. Alternatively, method 300 is performed at an off-site calibration facility, at least partially using off-site calibration system 240. Also, alternatively, the bi-directional communications links 252, 254, and 255 (all shown in FIG. 3) facilitate using off-site calibration system 240 for some, or all, of the determinations and calculations discussed further below.

The established calibration standard data is uploaded 302 into mobile calibration device 220. Such established calibration standard data includes any measurements already defined as correct measurements, for example, and without limitation, OEM calibration standards, actual measurement data recorded using standard measurement devices, e.g., and without limitation, calibration blocks and visual/physical verification, and recorded historical data. Generation of such established calibration data can be performed in the field or at an off-site calibration facility.

Communications are established 304 between field measurement apparatus 210 and mobile calibration device 220. In the exemplary embodiment, mobile calibration device 220 is wirelessly in communication with field measurement apparatus 210. Alternatively, mobile calibration device 220 is physically connected to field measurement apparatus 210 through an umbilical device, e.g., and without limitation, a USB cable. Firmware 297 (shown in FIG. 3) of field measurement apparatus 210 is placed 306 into “calibration mode”.

Field measurement apparatus 210 is manually exercised 308 through the full measurement range of travel, i.e., 0%-100%, 0 in.-4 in., and 4 ma-20 ma, up and down, multiple times. Such movement of magnetic sensor 290 with respect to magnetic band 292 (both shown in FIG. 4) is performed through relatively slow and steady manual movement by an operator or by a specialized translation device, i.e., a jig (not shown) coupled to magnetic sensor 290. The slow and steady translation of field measurement apparatus 210 generates an analog signal throughout the full spectrum of translation, such method in contrast to translating magnetic sensor 290 to discrete points along the full range of travel 288 (shown in FIG. 4). Alternatively, a set of calibration blocks (not shown) are used to facilitate positioning magnetic band 292 at predetermined points along full range of travel 288.

Raw data 309 (shown in FIG. 3) is transmitted 310 to mobile calibration device 220 as raw output signal data stream 311 (shown in FIG. 3) from magnetic sensor 290 through output signal cable 294. Raw data storage module 260 (shown in FIG. 3) receives and stores output signal data stream 311 collected from field measurement apparatus 210. In addition to collection of raw output signal data stream 311, an operator manually records 312 the actual physical measurement of the position of magnetic sensor 290 as it is translated through full range of travel 288 using, for example, and without limitation, calibration blocks and verified markings on magnetic band 292. In some embodiments, the manually recorded actual physical measurement of field measurement apparatus 210 is manually input 314 into established calibration standard data module 256 and merged 316 in with the existing standard data stored in established calibration standard data module 256. In some embodiments, the manually recorded actual physical measurement of field measurement apparatus 210 manually input 314 is the first data entered into established calibration standard data module 256 and becomes the sole existing standard data.

An initial raw output data stream 317 is transmitted from raw data storage module 260 to established calibration standard data module 256 and raw output data stream 317 is compared 318 with the established calibration standard data in established calibration standard data module 256. An initial measurement difference data stream 319 representative of a difference between raw output data stream 317 and the established calibration standard data is generated 320 and initial measurement difference data stream 319 is transmitted 322 to transfer function module 258.

An initial transfer function, i.e., corrective algorithm based on initial measurement difference data stream 319 is generated 324 within transfer function module 258. The corrective algorithm includes coefficients that are adjustable to generate updated calibration standard data as the condition of field measurement apparatus 210 changes with time, thereby facilitating adjustments to the calibration of field measurement apparatus 210. The corrective algorithm may be either linear or nonlinear.

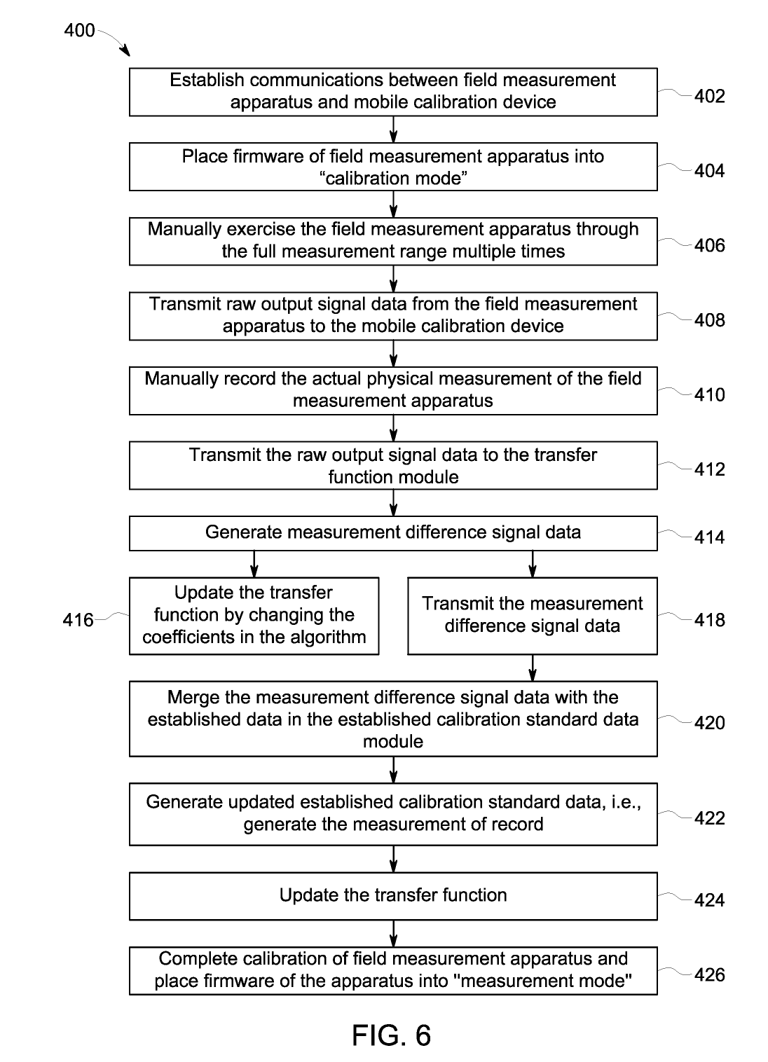

FIG. 6 is a flow chart for an exemplary method 400 of calibrating field measurement apparatus 210 (shown in FIGS. 2, 3, and 4) using meteorological system 200 (shown in FIGS. 2 and 3). The purpose of method 400 is to facilitate routine calibration checks and, if necessary, recalibration of field measurement apparatus 210. Specifically, the established calibration standard data and the corrective algorithm are stored within mobile calibration device 220 and off-site calibration system 240 (both shown in FIGS. 2 and 3). Method 400 is performed in the field with mobile calibration device 220 proximate field measurement apparatus 210. Alternatively, method 400 is performed at an off-site calibration facility, at least partially using off-site calibration system 240. Also, alternatively, the bi-directional communications links 252, 254, and 255 (all shown in FIG. 3) facilitate using off-site calibration system 240 for some, or all, of the determinations and calculations discussed further below.

Communications are established 402 between field measurement apparatus 210 and mobile calibration device 220. In the exemplary embodiment, mobile calibration device 220 is wirelessly in communication with field measurement apparatus 210. Alternatively, mobile calibration device 220 is physically connected to field measurement apparatus 210 through an umbilical device, e.g., and without limitation, a USB cable. Firmware 297 (shown in FIG. 3) of field measurement apparatus 210 is placed 404 into “calibration mode”.

Field measurement apparatus 210 is manually exercised 406 through the full measurement range of travel, i.e., 0%-100%, 0 in.-4 in., and 4 ma-20 ma, up and down, multiple times. Such movement of magnetic sensor 290 with respect to magnetic band 292 (both shown in FIG. 4) is performed through relatively slow and steady manual movement by an operator or by a specialized translation device, i.e., a jig (not shown) coupled to magnetic sensor 290. The slow and steady translation of field measurement apparatus 210 generates an analog signal throughout the full spectrum of translation, such method in contrast to translating magnetic sensor 290 to discrete points along the full range of travel 288 (shown in FIG. 4). Alternatively, a set of calibration blocks (not shown) are used to facilitate positioning magnetic band 292 at predetermined points along full range of travel 288.

Raw data 309 (shown in FIG. 3) is transmitted 408 to mobile calibration device 220 as raw output signal data stream 311 (shown in FIG. 3) from magnetic sensor 290 through output signal cable 294. Raw data storage module 260 (shown in FIG. 3) receives and stores output signal data stream 311 collected from field measurement apparatus 210. In addition to collection of raw output signal data stream 311, as an optional step, an operator manually records 410 the actual physical measurement of the position of magnetic sensor 290 as it is translated through full range of travel 288 using, for example, and without limitation, calibration blocks and verified markings on magnetic band 292. In some embodiments, the manually recorded actual physical measurement of field measurement apparatus 210 is manually input 314 into established calibration standard data module 256 and merged 316 in with the existing standard data stored in established calibration standard data module 256. In other embodiments, the manually recorded actual physical measurement of field measurement apparatus 210 is held as additional, stand-alone data that may be stored for reference at a later date.

Raw output signal data stream 311 is transmitted 412 to transfer function module 258, where data stream 311 is channeled through the corrective algorithm to generate 414 measurement difference data stream 413 (shown in FIG. 3) to determine if raw measurement output data stream 311 is within established parameters. The established thresholds for measurement difference data stream 413 are based on a predetermined level of precision for the respective field measurement apparatus 210.

If measurement difference data stream 413 is within established parameters, then field measurement apparatus 210 is within calibration specifications, the operator breaks communications link 250, and no further action is taken. A measurement of record is generated that is stored and that facilitates subsequent efforts to review calibration trending for field measurement apparatus 210.

If measurement difference data stream 413 is not within established parameters, i.e., then field measurement apparatus 210 is not within calibration specifications and recalibration is required. As such, two different actions may be executed, i.e., either or both of the established calibration standard data and the corrective algorithm. In general, the actions taken substantially depend on the reasons for the variance, the details of the variance, and the details of the apparatus.

Therefore, the operator will most likely play a role in determining which action to take based on the information at the operator's disposal. For example, the spacing between the permanent magnets on magnetic band 292 are unlikely to change, therefore this condition will most likely be removed from possible reasons for the variance. However, measurement readings from field measurement apparatus 210 may be temperature dependent and the standard data may need to be adjusted for a temperature dependency and the corrective algorithm will most likely not need to be updated. Also, actuator drive 272 exerts a longitudinal force on actuator rod 274 that pulls on mechanical coupler 278 and small amounts of play may develop between actuator rod 274 and linear gate device 276 at mechanical coupler 278.

To determine potential causes for the data variance, the operator will review the actual physical data recorded in method step 410 and compare to the most current version of the calibration standard data. If the recorded physical data is close to the standard data, i.e., any variance is within the threshold parameters, and there is no reason to believe the calibration standard data has changed, and the physical measurement data indicates that the apparatus has not changed, then the corrective algorithm may need to be updated 416 by adjusting the coefficients in the algorithm.

Alternatively, if the recorded physical data is not within threshold parameters, then apparatus 210 may have experienced physical changes and the established calibration standard data will need to be updated. Measurement difference data stream 413 is transmitted 418 from transfer function module 258 to established calibration standard data module 256. Measurement difference data stream 413 is merged 420 with the established data in established calibration standard data module 256. Updated established calibration standard data is generated 422, i.e., a measurement of record is generated. Once the established calibration standard data is updated, the corrective algorithm is updated 424 accordingly.

In the exemplary embodiment, calibration of field measurement apparatus 210 is completed 426 and firmware 297 of field measurement apparatus 210 is placed into “measurement mode”.

As used herein, field measurement apparatus 210 is determined to be calibrated, i.e., transmitting measurement data, i.e., analog signals 293 to instrument 296 and analog gauge 295, such measurement data within established calibration standards such that operators of field control device 270 are confident of the precision and accuracy of the indications available to them. Such calibration of apparatus 210 is accomplished through at least one of a number of methods and mechanisms.

In the exemplary embodiment, a calibration measurement correction data stream 425 is transmitted to firmware 297 of field measurement apparatus 210. Calibration measurement correction data 425 is in the form of, without limitation, a corrective algorithm or a look-up table implemented in a software-based correction module (not shown) that facilitates correcting raw data 309 to more accurately and precisely indicate a position of linear gate device 276 within fluid conduit 280 on analog gauge 295. In some embodiments, updated established calibration standard data is also transmitted to field measurement apparatus 210 for storage. Also, in some of embodiments, such correction module is configured to generate a notification to operator 125 if correction of raw data 309 requires correction factors outside of predetermined parameters such that an indication of a potential measurement issue is presented to operator 125.

In some alternative embodiments, mobile calibration device 220 is maintained in substantially constant communication with field measurement apparatus 210 through either of, or both of, local communications link 250 and external communications links 252 and 255 (through network 230). In such alternative embodiments, calibration measurement correction data 425, in the form of, without limitation, a corrective algorithm or a look-up table implemented in a software-based correction module (not shown), is resident within mobile calibration device 220 such that raw data 309 is corrected to more accurately and precisely indicate a position of linear gate device 276 within fluid conduit 280 on analog gauge 295. Such corrected measurement data is transmitted to instrument 296 and gauge 295 either directly from mobile calibration device 220 or through field measurement apparatus 210. Also, in some of these alternative embodiments, such correction module is configured to generate a notification to operator 125 if correction of raw data 309 requires correction factors outside of predetermined parameters such that an indication of a potential measurement issue is presented to operator 125.

In some other alternative embodiments, off-site calibration system 240 is maintained in substantially constant communication with field measurement apparatus 210 through external communications links 254 and 255 (through network 230). Such alternative embodiments are useful for when mobile calibration device 220 does not remain proximate field measurement device 210. In such alternative embodiments, calibration measurement correction data 425, in the form of, without limitation, a corrective algorithm or a look-up table implemented in a software-based correction module (not shown) is resident within off-site calibration system 240 such that raw data 309 is corrected to more accurately and precisely indicate a position of linear gate device 276 within fluid conduit 280 on analog gauge 295. Such corrected measurement data is transmitted to instrument 296 and gauge 295 either directly from off-site calibration system 240, through mobile calibration device 220, or through field measurement apparatus 210. Also, in some of these alternative embodiments, such correction module is configured to generate a notification to operator 125 if correction of raw data 309 requires correction factors outside of predetermined parameters such that an indication of a potential measurement issue is presented to operator 125.

Under some circumstances, the operator of mobile calibration device 220 may determine (through determining component 224 (shown in FIG. 2)) that field measurement apparatus 210 cannot be calibrated using mobile calibration device 220 in a stand-alone manner. One potential reason is that apparatus 210 has physical deficiencies that calibration through either mobile calibration device 220 or off-site calibration system 240 cannot alleviate. Therefore, mobile calibration device 220, in communication with off-site calibration system 240, will facilitate determining which calibration facility the respective field measurement apparatus 210 should be sent to and provide instructions on how to ship it.

Also, under some circumstances, mobile calibration device 220 may determine (through determining component 224) and inform the operator through display component 228 (shown in FIG. 2) that a replacement corrective algorithm or replacement established calibration standard data is required to calibrate field measurement apparatus. Moreover, instructions to the operator for executing the necessary actions are also provided. Mobile calibration device 220 communicates with off-site calibration system 240 to retrieve the appropriate replacement corrective algorithm and standard data such that on-site calibration activities can continue without removing field measurement apparatus 210 from the site.

Further, under some circumstances, mobile calibration device 220, with or without consultation with off-site calibration system 240, determines (through determining component 224) that the raw data collected on-site should be sent to off-site calibration system 240 for assistance and analysis.

Moreover, under some circumstances, a physical characteristic of field measurement device 210 may need to be altered. Such alterations include, and without limitation, positioning a set screw, adjusting a potentiometer to alter voltages, replacing a travel stop device, and altering a drive gear ratio.

The above described calibration systems and methods provide cost-effective methods for calibrating field measurement apparatus. Specifically, utilizing the embodiments described herein, a field measurement apparatus is calibrated on-site using a mobile calibration device. Calibrating field measurement apparatus on-site reduces the potential for the field measurement apparatus being taken out of service, physically removed from the premises, and sent to a centralized calibration facility that is typically located a significant distance from the calibration facilities. Therefore, a time period for which the associated field measurement apparatus is considered “out-of-service” is significantly reduced. In addition, the he costs associated with the labor to remove, ship, and reinstall the apparatus, the shipping costs, and any loss of revenue associated with shutting the associated process down is significantly reduced. Furthermore, reliance on specialized calibration equipment that may be usable only with certain makes and models of field measurement apparatus, and also needs to be calibrated, is significantly reduced. Moreover, the meteorological systems and methods described below facilitate data preservation through network-based, including cloud-mediated, storage and data transfer such that each measurement apparatus has its own history.

An exemplary technical effect of the methods and systems described herein includes at least one of: (a) extended reliability, precision, and accuracy of field measurement apparatus in the field; (b) extended availability of the measurement apparatus in the field; (c) improved field measurement apparatus performance and tracking; (d) increased measurement apparatus utilization in the field; (e) increased measurement reliability; (f) reduced number of ready spare field measurement apparatus needed for a remote site; and (g) a savings of time due to a decrease in the time field measurement apparatus are out-of-service.

Exemplary embodiments of methods and systems for calibrating a field measurement apparatus on-site, determining a location for calibration of field measurement apparatus, and determining a type of location at which a measurement apparatus can be calibrated are not limited to the specific embodiments described herein, but rather, components of systems and/or steps of the methods may be utilized independently and separately from other components and/or steps described herein. For example, the methods may also be used in combination with other on-site calibrators to determine a location for calibration of field measurement apparatus, and are not limited to practice with only one on-site calibrator. Rather, the exemplary embodiments can be implemented and utilized in connection with many other applications, equipment, and systems that may benefit from calibrating field measurement apparatus on-site, determining a location for calibration of field measurement apparatus, and determining a type of location at which field measurement apparatus can be calibrated.

Although specific features of various embodiments of the disclosure may be shown in some drawings and not in others, this is for convenience only. In accordance with the principles of the disclosure, any feature of any drawing may be references and/or claimed in combination with any feature of any other drawing.

Some embodiments involve the use of one or more electronic or computing devices. Such devices typically include a processor or controller, such as a general purpose central processing unit (CPU), a graphics processing unit (GPU), a microcontroller, a reduced instruction set computer (RISC) processor, an application specific integrated circuit (ASIC), a programmable logic circuit (PLC), and/or any other circuit or processor capable of executing the functions described herein. The methods described herein may be encoded as executable instructions embodied in a computer readable medium, including, without limitation, a storage device and/or a memory device. Such instructions, when executed by a processor, cause the processor to perform at least a portion of the methods described herein. The above examples are exemplary only, and thus are not intended to limit any way the definition and/or meaning of the term processor.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structure elements that do not differ from the literal language of the claims, or if they include equivalent structural elements with insubstantial differences from the literal language of the claims.

What is claimed is:

1. A meteorological system for calibrating a field measurement apparatus, said system comprising:
a field measurement apparatus coupled to a field device, said field measurement apparatus configured to generate measurement signals corresponding to a physical measurement associated with the field device within a predetermined range of measurements, wherein the measurement signals define a raw data stream; and
a mobile calibration device comprising:
a transfer function module including a corrective algorithm resident thereon; and
a calibration standard data module including calibration standard data associated with said field measurement apparatus resident thereon, said mobile calibration device configured to:
establish bi-directional communication with said field measurement apparatus;
facilitate shifting said field measurement apparatus to a calibration mode;
receive the raw data stream from said field measurement apparatus;
transmit the raw data stream to said transfer function module, said transfer function module configured to generate a difference data stream through the corrective algorithm; and
calibrate said field measurement apparatus.

2. The meteorological system in accordance with claim 1, wherein said mobile calibration device further comprises a computing device comprising at least one processor and a memory device coupled to said at least one processor, said at least one processor configured to determine one of:
said field measurement apparatus cannot be calibrated by said mobile calibration device proximate the remote work site; and
said field measurement apparatus can be calibrated by said mobile calibration device proximate the remote work site.

3. The meteorological system in accordance with claim 2, wherein said at least one processor is further configured to determine a location at which said field measurement apparatus can be calibrated.

4. The meteorological system in accordance with claim 1, wherein said field measurement apparatus comprises a read only memory (ROM) device, wherein said ROM device includes calibration measurement correction data associated with said field measurement apparatus therein, said mobile calibration device further configured to modify at least a portion of the calibration measurement correction data stored on said ROM device.

5. The meteorological system in accordance with claim 1 further comprising a remote calibration system, wherein said mobile calibration device is further configured to establish bi-directional communication with said remote calibration system, said remote calibration system configured to store the corrective algorithm and at least a portion of the calibration standard data, said mobile calibration device further configured to download data associated with said field measurement apparatus from said remote calibration system and upload data associated with said field measurement apparatus to said remote calibration system.

6. The meteorological system in accordance with claim 1, said mobile calibration device further configured to modify the corrective algorithm and modify at least a portion of the calibration standard data.

7. The meteorological system in accordance with claim 1, wherein said mobile calibration device comprises a hand-held device comprising one of a laptop computer, a smart phone, a tablet computer, and a personal digital assistant (PDA).

8. The meteorological system in accordance with claim 1, wherein said mobile calibration device comprises a calibrating component, wherein said calibrating component includes calibration measurement correction data associated with said field measurement apparatus therein, said mobile calibration device further configured to modify at least a portion of the raw data stream to generate corrected measurement data.

9. The meteorological system in accordance with claim 1 further comprising a remote calibration system, wherein said remote calibration system comprises a calibrating component, wherein said calibrating component includes calibration measurement correction data associated with said field measurement apparatus therein, said remote calibration system further configured to modify at least a portion of the raw data stream to generate corrected measurement data.

10. A method of determining a calibration status of a field measurement apparatus, said method comprising:
establishing bi-directional communication with the field measurement apparatus through a mobile calibration device;
exercising the field measurement apparatus through a predetermined range of physical translation;
generating measurement signals corresponding to the physical translation, wherein the measurement signals define a raw data stream;
transmitting the raw data stream from the field measurement apparatus to a transfer function module within the mobile calibration device;
determining a difference signal from a first corrective algorithm resident within the transfer function module; and
calibrating the field measurement apparatus.

11. The method in accordance with claim 10 further comprising generating the first corrective algorithm comprising:
recording actual physical measurement data of the field measurement apparatus while exercising the field measurement apparatus through the predetermined range of physical translation;
manually inputting the recorded actual physical measurement data of the field measurement apparatus into a calibration standard data module within the mobile calibration device, thereby merging the recorded actual physical measurement data of the field measurement apparatus with existing calibration standard data associated with the field measurement apparatus, thereby generating established calibration standard data;
comparing the raw data stream with the established calibration standard data;
generating an initial measurement difference data stream representative of a difference between the raw data stream and the established calibration standard data;
transmitting the initial measurement difference data stream to the transfer function module; and
generating an initial transfer function based on the initial measurement difference data stream.

12. The method in accordance with claim 10 further comprising determining one of:
the field measurement apparatus cannot be calibrated by the mobile calibration device proximate the remote work site; and
the field measurement apparatus can be calibrated by the mobile calibration device proximate the remote work site.

13. The method in accordance with claim 12 further comprising determining a location at which the field measurement apparatus can be calibrated.

14. The method in accordance with claim 11, wherein determining that the field measurement apparatus cannot be calibrated proximate the remote work site with the mobile calibration device comprises determining that the corrective algorithm is not configured to calibrate the field measurement apparatus.

15. The method in accordance with claim 12 further comprising providing an indication to a user that the field measurement apparatus cannot be calibrated proximate the remote work site.

16. The method in accordance with claim 14, wherein providing an indication comprises providing one or more of a visual alert and an audio alert.

17. The method in accordance with claim 12 further comprising:
establishing bi-directional communication with a remote calibration system and the mobile calibration device, the remote calibration system configured to store the first corrective algorithm and at least a portion of the established calibration standard data;
downloading data associated with the field measurement apparatus to the mobile calibration device from the remote calibration system; and
uploading data associated with the field measurement apparatus to remote calibration system from the mobile calibration device.

18. The method in accordance with claim 17, wherein downloading data associated with the field measurement apparatus comprises at least one of:
downloading additional calibration data associated with the field measurement apparatus; and
downloading a second corrective algorithm different from the first corrective algorithm.

19. The method in accordance with claim 17, wherein uploading data associated with the field measurement apparatus comprises uploading one of:
the raw data stream;
the established calibration data; and
the first corrective algorithm.

20. The method in accordance with claim 17, wherein calibrating the field measurement apparatus comprises transmitting calibration measurement correction data to at least one of the field measurement apparatus, the remote calibration system and the mobile calibration device.

21. The method in accordance with claim 10 further comprising one of:
modifying the first corrective algorithm; and
modifying at least a portion of the established calibration standard data, thereby generating updated calibration standard data.

22. The method in accordance with claim 21 further comprising providing at least one instruction to a user of the mobile calibration device for selecting whether to modify the first corrective algorithms or modify the at least a portion of the established calibration data.

23. The method in accordance with claim 10 further comprising providing at least one instruction to a user of the measurement apparatus for exercising the field measurement apparatus through the predetermined range of physical measurements.

24. The method in accordance with claim 23, wherein providing the at least one instruction includes providing procedures for the user to obtain measurement information using the field measurement apparatus against a calibrated component such that the measurements of the calibrated component are associated with the calibration standard data and the measurements taken by the field measurement apparatus are associated with the measured data.
